(19) United States
(12) Patent Application Publication
(10) Pub. No.: US 2015/0159015 A1
(43) Pub. Date: Jun. 11, 2015

(54) POLYAMIDE COMPOSITIONS

(71) Applicant: LANXESS Deutschland GmbH, Cologne (DE)

(72) Inventors: Tobias BENIGHAUS, Muenster (DE); Detlev JOACHIMI, Krefeld (DE)

(21) Appl. No.: 14/559,554

(22) Filed: Dec. 3, 2014

(30) Foreign Application Priority Data
Dec. 5, 2013 (EP) 13195820.9

(51) Int. Cl. C08L 77/06; C08L 77/02

(52) U.S. Cl. CPC C08L 77/06; C08L 77/02; C08L 2205/02

(57) ABSTRACT

The present invention relates to compositions based on at least one polyamide containing at least one polyol and at least one copolymer of at least one olefin with at least one methacrylate or acrylate of an aliphatic alcohol, and to processes for producing moulding compositions from the inventive compositions and products that can be produced therefrom, especially fibres, films and mouldings formed from these moulding compositions, and the use thereof.

The present invention relates to compositions based on at least one polyimide containing at least one polyol and at least one copolymer of at least one olefin with at least one methacrylate or acrylate of an aliphatic alcohol. The invention further relates to a process for producing moulding compositions from the inventive compositions, and to products, especially fibres, films and mouldings, formed from these moulding compositions, and to the use thereof. This invention additionally relates to the use of the copolymer claimed for reduction of deposit formation by polyamides moulding compositions, or products obtainable from these moulding compositions, containing at least one polyol from the group of pentaerythritol, dipentaerythritol and tripentaerythritol.

### PRIOR ART

Polyamides are frequently used as materials for mouldings which are exposed to elevated temperatures over a prolonged period during their lifetime. For a multitude of applications, it is necessary at the same time that the materials have sufficient stability to thermooxidative damage which can occur in the course of the lifetime of a product produced from these components, especially when such products are employed in the engine space of motor vehicles.

Polyamides generally exhibit a deterioration in their mechanical properties when they are subjected to elevated temperatures over a prolonged period. This effect is based primarily on oxidative damage to the polymer at elevated temperatures (thermooxidative damage). A prolonged period in the context of the present invention means longer than 100 hours; elevated temperatures in the context of the present invention means higher than 80° C.

The stability of thermoplastic moulding compositions to thermooxidative damage is typically assessed by the comparison of mechanical properties, especially by comparison of the breaking stress and elongation at break at defined temperature over a defined period, measured in the tensile test to ISO 527.

Numerous systems for stabilization of polymers against thermooxidative damage and the resulting molecular breakdown are known and have been described in the literature. A summary can be found in the “Plastic Additives Handbook”, 5th edition, editor: Hans Zweifel, Carl Hanser Verlag, Munich 2001, on pages 10 to 19 and 40 to 92. In technical thermoplastics, especially polyamides, it is customary to use antioxidants based on sterically hindered phenols or based on aromatic amines as organic stabilizers, or systems based on copper compounds as inorganic stabilizers. These organic stabilizers are generally used at temperatures up to about 120° C.; some are still effective even at higher temperatures. Effective stabilization at high temperatures up to about 140° C. is typically achieved by stabilizer systems based on mixtures of copper halides and alkali metal halides.

hi the last few years, the demands on the use temperatures at which polyamides still have sufficient stability have risen significantly. In many applications, long-term thermal stabilization against thermooxidative degradation is required at 160° C., or even at temperatures up to the range from 180 to 200° C. In the context of the present invention, “long-term” for the tests was fixed at a duration in the region of 1000+/−10 hours. The addition of polyols to polyamide-based moulding compositions is one way of stabilizing polyamides for use at temperatures in the range from 180 to 200° C. Particularly the polyols pentaerythritol, dipentaerythritol and tripentaerythritol have been found to be potent stabilizers at such temperatures.

WO2010014785 A1 describes polyamide moulding compositions which are stabilized by addition of polyols, particularly dipentaerythritol and tripentaerythritol, for temperatures up to 230° C.

WO2011014556 A1 teaches that it is also possible to stabilize polyamide moulding compositions based on mixtures of partly aromatic polyamides and amorphous polyamides with these polyols.

CN102030982 A describes a stabilizer system for polyamide moulding compositions, consisting of an elemental metal and polyols, especially dipentaerythritol.

In addition, short-chain polyols are typically also used to improve the flowability of polyamide-based moulding compositions.

For instance, EP 1041109 A2 describes polyamide-based moulding compositions, the flowability of which is distinctly improved by the addition of polyols, particularly also of pentaerythritol and dipentaelythritol, without distinctly worsening the mechanical properties of the moulding compositions.

WO2010014785 A1 describes the provision of thermoplastic articles based, for example, on polyamide (6T/DT), a polyol, glass fibres and further additives stable to thermooxidative damage.

WO2007036929 A1 describes a process for producing polyamide resins having improved flowability, in which polyol, particularly also pentaerythritol, is added to the polyamide during the polymerization.

However, polyamide-based moulding compositions of this kind that contain polyols have the disadvantage that the polyols partly migrate to the surface under moist climatic conditions. Moist climatic conditions in the context of this invention are present when the temperature is higher than 25°° C. and the relative humidity is higher than 65%. This migration leads to formation of deposits at the surfaces of mouldings, fibres or films which are manufactured from such polyamide moulding compositions. Surface deposits of this kind are deleterious to the customer's aesthetic perception and can also considerably reduce the adhesion of adhesives or sealants.

The problem addressed by the present invention was therefore that of providing polyimide-based compositions and thermoplastic moulding compositions that can be produced therefrom and contain polyols, and therefore have improved stability against thermooxidative damage and improved flowability, but at the same time form surface deposits under moist climatic conditions to a much lesser degree.

Flowability of thermoplastic moulding compositions is typically assessed via the comparison of melt viscosity or of volume flow index. Melt viscosity is determined in general, and also within the context of the present invention, in a capillary viscometer to ISO 11443, Low values for melt viscosity indicate good flowability. In this context, the shear rate range of about 1000 1/s to 1500 1/s is of particular relevance for conclusions about flowability in the injection moulding process. Volume flow index is determined in general, and also within the context of the present invention, to DIN EN ISO 1133-1 at defined temperature and defined load. A high volume flow index value indicates good flowability.

The use of copolymers of at least one olefin with at least one methacrylate or acrylate of an aliphatic alcohol as flow improver for polyamide-based moulding compositions is known from WO 2005/121249 A1.

It has been found that, surprisingly, at least one copolymer of at least one olefin with at least one methacrylate or acrylate of an aliphatic alcohol can distinctly reduce migration of the polyols under moist climatic conditions, without significantly reducing the positive effects of the polyols on flowability and stability to thermooxidative degradation, Stability to thermooxidative degradation was determined in the context of the present invention via the breaking stress. Breaking force is a term used in materials testing for the force which is required to break or tear a test specimen. Breaking force is usually reported as force (in N) or—with respect to the cross-sectional area of the sample—as breaking stress (in N/mm²). In the tensile test or flexural test, it is defined via the drop in force which occurs when the force maximum at which the material still deforms elastically is exceeded. If the force drops, for example, by 20%, the universal test recognizes that the sample has broken. In the context of the present invention, breaking stress σ_{B} was determined to EN ISO 527-1 (ISO Version of February 2012) by tensile tests with a tensile tester (see also: http://de.wikipedia.org/wiki/Zugpr%C3%BCfmaschine).

### SUMMARY OF THE INVENTION

The solution to the problem, and hence the subject-matter of the present invention, is therefore the use of at least one of the abovementioned copolymers for reducing formation of deposits, under moist climatic conditions, in thermoplastic moulding compositions or products that can be produced therefrom which contain polyamide and at least one polyol, the polyols being organic molecules having at least two and not more than 12 hydroxyl groups per molecule and a mean relative molecular mass in the range from 64 to 2000 g/mol, where the number-average molecular weight (Mₙ) replaces the relative molecular mass for that part of the mixture in the case of use of polyols that are mixtures of oligomeric and/or polymeric polyols.

The invention also provides compositions comprising

(a) 10% to 99,8% by weight of at least one polyamide,

(b) 0.1% to 10% by weight, preferably 0.5% to 10% by weight, more preferably 1% to 8% by weight, most preferably 2% to 7% by weight, of at least one polyol having at least two and not more than 12 hydroxyl groups per molecule and a mean relative molecular mass in the range from 64 to 2000 g/mol and

(c) 0.1% to 10% by weight, preferably 0.5% to 10% by weight, more preferably 1% to 9% by weight, most preferably 2% to 8% by weight, of at least one copolymer of at least one olefin with at least one methacrylate or acrylate of an aliphatic alcohol which has a melt flow index (MFI) measured at 190° C. with a load of 2.16 kg in the range from 100 g/10 min to 800 g/10 min, with the proviso that the sum total of all the percentages by weight is always 100 and, in the case of use of polyols (b) which are mixtures of oligomeric and/or polymeric polyols, it is the number-average molecular weight (Mₙ) rather than the relative molecular mass that determines the limit of the range for this part of the mixture.

The inventive compositions are formulated for further utilization by mixing the components (a), (b) and (c) for use as reactants in at least one mixing apparatus. This gives, as intermediates, moulding compositions based on the inventive compositions. These moulding compositions—also referred to as thermoplastic moulding compositions—may either consist exclusively of components (a), (b) and (c), or else contain further components in addition to components (a), (b) and (c). In this case, components (a), (b) and (c) should be varied within the scope of the ranges specified such that the sum total of all the percentages by weight is always 100. In the case of thermoplastic moulding compositions and products that can be produced therefrom, the proportion of the inventive compositions therein is preferably in the range from 50% to 100% by weight, more preferably in the range from 90% to 100% by weight, the further components or other constituents being additives selected by the person skilled in the art in accordance with the later use of the products, preferably from at least one of components (d) to (f) defined hereinafter.

For clarity, it should be noted that the scope of the present invention encompasses all the definitions and parameters mentioned hereinafter in general terms or specified within areas of preference, in any desired combinations.

### PREFERRED EMBODIMENTS OF THE INVENTION

In a preferred embodiment, the inventive compositions comprise, addition to components (a) to (c), also

(d) 5% to 80% by weight of at least one filler or reinforcer, preferably glass fibres or carbon fibres, more preferably glass fibres, where the proportions of components (a) to (c) should be reduced such that the sum total of all the percentages by weight is always 100.

In a preferred embodiment, the inventive compositions comprise, in addition to components (a) to (d) or instead of (d), also

(e) 0.1% to 20% by weight of at least one form of carbon black and/or nigrosin, preferably carbon black, where the proportions of at least one of components (a) to (c) and any (d) should be reduced such that the sum total of ail the percentages by weight is always 100.

In a preferred embodiment, the inventive compositions comprise, in addition to components (a) to (e) or instead of (d) and/or (e), also

(f) 0.1% to 20% by weight of at least one further ingredient other than components (b), (c), (d) and (e), where the proportions of at least one of components (a) to (c) and any (d) and/or (e) should be reduced such that the sum total of all the percentages by weight is always 100.

Preference is given in accordance with the invention to compositions comprising

(a) 10% to 94.3% by weight of at least one polyamide,

(b) 0.1% to 10% by weight, preferably 0.5% to 5% by weight, more preferably 1% to 4% by weight, of at least one polyol having at least two and not more than 12 hydroxyl groups per molecule and a mean relative molecular mass in the range from 64 to 2000 g/mol and

(c) 0.1% to 10% by weight, preferably 0.5% to 6% by weight, more preferably 1% to 6% by weight, of at least one copolymer of at least one olefin with at least one methacrylate or acrylate of an aliphatic alcohol which has a melt flow index (MFI) measured at 100° C. with a load of 2.16 kg in the range from 100 g/10 min to 800 g/10 min and

(d) 5% to 80% by weight, preferably 10% to 70% by weight, more preferably 15% to 65% by weight, of at least one filler or reinforcer, and

(e) 0.1% to 20% by weight of at least one form of carbon black and/or nigrosin, preferably at least one form of carbon black, where the sum total of all the percentages by weight is always 100 and, in the case of use of polyols (b) which are mixtures of oligomeric and/or polymeric polyols, it is the number-average molecular weight (Mₙ) rather than the relative molecular mass that determines the limit of the range for that part of the mixture.

Preference is also given in accordance with the invention to compositions comprising

(a) 10% to 94.2% by weight of at least one polyamide,

(b) 0.1% to 10% by weight, preferably 0.5% to 5% by weight, more preferably 1% to 4% by weight, of at least one polyol having at least two and not more than 12 hydroxyl groups per molecule, where the mean relative molecular mass thereof is in the range from 64 to 2000 g/mol, and

(c) 0.5% to 10% by weight, preferably 0.5% to 6% by weight, more preferably 1% to 6% by weight, of at least one copolymer of at least one olefin with at least one methacrylate or acrylate of an aliphatic alcohol which has a melt flow index (MFI) measured at 190° C. with a load of 2.16 kg in the range from 100 g/10 min to 800 g/10 min and

(d) 5% to 80% by weight, preferably 10% to 70% by weight, more preferably 15% to 65% by weight, of at least one filler or reinforcer, and

(e) 0.1% to 20% by weight of at least one form of carbon black and/or nigrosin, preferably at least one form of carbon black, and

(f) 0.1% to 20% by weight of at least one further ingredient other than components (b), (c), (d) and (e), where the sum total of all the percentages by weight is always 100 and, in the case of use of polyols (b) which are mixtures of oligomeric and/or polymeric polyols, it is the number-average molecular weight (Mₙ) rather than the relative molecular mass that determines the limit of the range for that part of the mixture.

The present invention additionally relates to the use of the inventive compositions for production of thermoplastic moulding compositions, and in turn to the use of the latter in injection moulding, in blow moulding or extrusion for production of products, especially fibres, films or mouldings, of any kind.

The present invention further relates to the use of these products for production of articles for the electrical, electronics, telecommunications, information technology, solar and computer industries, for the household, for sport, for medical applications or for the entertainment industry, more preferably for motor vehicles, most preferably for the engine compartment of motor vehicles.

Component (a)

The polyamides for use as component (a) may be amorphous polyamides, semicrystalline polyamides or partly crystalline polyamides. The polyamides for use as component (a) are preferably partly crystalline polyamides, more preferably partly crystalline polyamides having a melting point of at least 180° C.

The partly crystalline polyamides for use as component (a) in one embodiment are preferably selected from the group of PA6, PA66, PA610, PA612, PA10, PA810, PA106, PA1010, PA11, PA1011, PA1012, PA1210; PA1212, PA814, PA1014, PA618, PA512, PA613, PA813, PA914, PA1015, PA11, PA12 and a partly aromatic polyamide called a polyphthalamide (PPA). Preferred PPM are PA66/6T, PA6/6T, PA6T/MPMDT (MPMD stands for 2-methylpentamethylenediamine), PA9T, PA10T, PA11T, PA12T, PA14T and copolycondensates of these latter types with an aliphatic diamine and an aliphatic dicarboxylic acid or with an α,ω-aminocarboxylic acid or a lactam. Partly crystalline polyamides have, according to DE 10 2011 084 519 A1, an enthalpy of fusion of more than 25 J/g, measured by the DSC method to ISO 11357 in the 2nd heating operation and integration of the melt peak, More preferably in accordance with the invention, the partly crystalline polyamide used in component (a) is PA6 or PA66 or a copolyamide of P6 or PA66.

The semicrystalline polyamide for use as component (a) in one embodiment has, according to DE 10 2011 084 519 A1, an enthalpy of fusion in the range from 4 to 25 J/g, measured by the DSC method to ISO 11357 in the 2nd heating operation and integration of the melt peak. Preferred semicrystalline polyamides are those which are prepared proceeding from diamines and dicarboxylic acids and/or lactams having at least 5 ring members or corresponding amino acids. Useful reactants are preferably aliphatic and/or aromatic dicarboxylic acids, more preferably adipic acid, 2,2,4-trimethyladipic acid, 2,4,4-trimethyladipic acid, azelaic acid, sebacic acid, isophthalic acid, terephthalic acid, aliphatic and/or aromatic diamines, more preferably tetramethylenediamine, hexamethylenediamine, 2-methylpentane-1,5-diamine, nonane-1,9-diamine, 2,2,4- and 2,4,4-trimethylhexamethylenediamine, the isomeric diaminodicyclohexylmethanes, diaminodicyclohexylpropane, bis(aminomethyl)cyclohexane, phenylenediamine, xylenediamine, aminocarboxylic acids, especially aminocaproic acid, or the corresponding lecterns. Copolyamides of a plurality of the monomers mentioned are included.

In a preferred embodiment, a blend of different polyamides is also used as component (a). Very especially preferred, in addition, are most of the compounds based on PA6, PA66 and other compounds based on aliphatic or/and aromatic polyamides or copolyamides in which there are 3 to 11 methylene groups in the polymer chain for each polyamide group.

The nomenclature of the polyamides used in the context of the present invention corresponds to the international standard, the first number(s) indicating the number of carbon atoms in the starting diamine and the last number(s) the number of carbon atoms in the dicarboxylic acid. If only one number is stated, as in the case of PA6, this means that the starting material was an α,ω-aminocarboxylic add or the lactam derived therefrom, i.e. ε-caprolactam in the case of PA6; for further information, reference is made to H. Domininghaus, Die kunststoffe und ihre Eigenschaften [The Polymers and Their Properties], pages 272 ff., VDI-Verlag, 1976.

Preference is given to using, as component (a), at least one partly crystalline polyamide having a viscosity number determined in a 0.5% by weight solution in 96% by weight sulphuric add at 25° C. to ISO 307 in the range from 80 to 180 ml/g, more preferably in the range from 90 to 160 ml/g.

The amorphous polyamides for use in one embodiment have, according to DE 10 2011 084 519 A1, an enthalpy of fusion of less than 4 J/g, measured by the DSC method to ISO 11357 in the 2nd heating operation and integration of the melt peak. Amorphous polyamides for use in accordance with the invention are described in DE 10 2008 046 682 A1, which refers in turn to GB Patent 619 707, U.S. Pat. No. 2,494,563, U.S. Pat. No. 2,696,482, U.S. Pat. No. 2,516,585, U.S. Pat. No. 3,847,877, DE-A 15 95 354, U.S. Pat. No. 3,597,400, U.S. Pat. No. 3,842,045, CH Patent 4 49 257, DE-A 24 05 985, DE-A 29 36 759, EP 0 012 931, DE-C 26 42 244 and U.S. Pat. No. 4,293,687, the contents of which disclose illustrative amorphous polyamides in the context of the present invention, and the contents of which are hereby embraced in full.

The polyamides for use in the inventive compositions can be prepared by various processes and be synthesized from different monomers. There is a multitude of known procedures for preparation of polyamides, with use, depending on the desired end product, of different monomer units and different chain transfer agents to establish a desired molecular weight, or else different monomers with appropriate reactive groups for aftertreatments intended at a later stage.

The processes of industrial relevance for preparation of the polyamides for use as component (a) usually proceed via polycondensation in the melt. In the context of the present invention, the hydrolytic polymerization of lactams is also regarded as polycondensation.

Component (b)

The polyols for use in accordance with the invention as component (b) are also known by the names “polyalcohol” or “polyhydric alcohol”. The at least one polyol for use as component (b) in accordance with the invention comprises organic molecules having at least 2 and not more than 12 hydroxyl groups per molecule, where the mean relative molecular mass of the polyol(s) is in the range from 64 to 2000 g/mol. Preference is given to using polyols having at least 3 and at most 10 hydroxyl groups per molecule, more preferably having at least 4 and at most 8 hydroxyl groups per molecule. In the case of use of polyols (b) which are mixtures of oligomeric and/or polymeric polyols, it is the number-average molecular weight (Mₙ) rather than the relative molecular mass that is used to fix the limits of the range claimed for that part of the mixture.

The at least one polyol for use as component (b) preferably has an aliphatic or aromatic structure or a combination of these two structures.

In an alternative preferred embodiment, the aliphatic chains contain, within a polyol for use as component (b) in accordance with the invention, as well as carbon atoms, also heteroatoms, preferably nitrogen, oxygen or sulphur. The polyols for use in accordance with the invention, in a preferred embodiment, as well as the hydroxyl groups, also have further functional groups, preferably ether groups, carboxylic acid groups, amide groups or ester groups.

Polyols having more than two hydroxyl groups for use with particular preference as component (b) are those polyols having three hydroxyl groups from the group of glycerol, trimethylolpropane, 2,3-di(2′-hydroxyethyl)cyclohexan-1-ol, hexane-1,2,6-triol, 1,1,1-tris(hydroxymethyl)ethane, 3-(2′-hydroxyethoxy)propane-1,2-diol, 3-(2′-hydroxypropoxy)propane-1,2-diol, 2-(2′-hydroxyethoxy)hexane-1,2-diol, 6-(2′-hydroxypropoxy)hexane-1,2-diol, 1,1,1-tris[(2′-hydroxyethoxy)methyl]ethane, 1,1,1-tris-2′-hydroxypropoxymethylpropane, 1,1,1-tris(4′-hydroxyphenyl)ethane, 1,1,1-tris(hydroxyphenyl)propane, 1,1,3-tris(dihydroxy-3-methylphenyl)propane, 1,1,4-tris(dihydroxyphenyl)butane, 1,1,5-tris(hydroxyphenyl)-3-methylpentane, ditrimethylolpropane, ethoxylates and propoxylates of trimethylolpropane.

Polyols having more than three hydroxyl groups for use with particular preference as component (b) are polyols from the group of D-mannitol, D-sorbitol, dulcitol, arabitol, inositol, xylitol, talitol, allitol, altritol, adonitol, erythritol, threitol, pentaerythritol, dipentaerythritol and tripentaerythritol, and polyols from the group of the monosaccharides, especially mannose, glucose, galactose, fructose, D-xylose, arabinose, D-idose, D-erythrose, D-threose, D-ribose, D-lyxose, D-allose, D-altrose, D-gulose, D-talose, D-ribulose, D-erythrulose, D-xylulose, D-psicose, D-sorbose, D-tagatose, D-gluconic acid, D-sugar add, D-mannosugar add, mucic add, D-glucuronic add, D-mannonic add, ascorbic add, D-glucosamine, D-galactosamine.

Polyols used with very especial preference as component (b) are those having more than three hydroxyl groups. Very particular preference is given to using at least one polyol from the group of pentaerythritol, dipentaerythritol, tripentaerythritol and ditrimethylolpropane, with very especial preference for pentaerythritol, dipentaerythritol and tripentaerythritol and very particularly especial preference for dipentaerythritol.

Component (c)

As component (c), the inventive compositions contain at least one copolymer, preferably at least one random copolymer of at least one olefin, preferably α-olefin, and at least one methacrylate or acrylate of an aliphatic alcohol which has a melt flow index (MA) measured at 190° C. and a load of 2.16 kg of at least 100 g/10 min. In a preferred embodiment, the copolymer for use as component (c) consists to an extent of less than 4% by weight, more preferably to an extent of less than 1.5% by weight and most preferably to an extent of 0% by weight of monomer units containing further reactive functional groups selected from the group comprising epoxides, oxetanes, anhydrides, imides, aziridines, furans, acids, amines, oxazolines.

Suitable olefins, preferably α-olefins, as a constituent of the copolymers for use as component c) preferably have between 2 and 10 carbon atoms and may be unsubstituted or substituted by one or more aliphatic, cycloaliphatic or aromatic groups.

Preferred olefins are selected from the group comprising ethene, propene, 1-butene, 1-pentene, 1-hexene, 1-octane, 3-methyl-1-pentene. Particularly preferred olefins are ethane and propene, very particular preference being given to ethene.

Likewise suitable are mixtures of the olefins described.

In a further-preferred embodiment, the further reactive functional groups of the copolymer (c) are introduced into the copolymer (c) exclusively via the olefins, these functional groups being selected from the group comprising epoxides, oxetanes, anhydrides, imides, aziridines, furans, acids, amines, oxazolines.

The content of the olefin in the copolymer (c) is in the range from 50% to 90% by weight, preferably in the range from 55% to 75% by weight.

The copolymer (c) is also defined by the second constituent in addition to the olefin. Suitable second constituents are alkyl esters of acrylic acid or methacrylic acid, wherein the alkyl group is formed from 5-30 carbon atoms. The alkyl group may be linear or branched and contain cycloaliphatic groups, and may additionally also be substituted by one or more ether or thioether functions. Suitable methacrylic esters or acrylic esters in this context are also those which have been synthesized from an alcohol component based on oligoethylene glycol or oligopropylene glycol having only one hydroxyl group and not more than 30 carbon atoms.

The alkyl group of the methacrylate or the acrylate is preferably selected from the group comprising 1-pentyl, 1-hexyl, 2-hexyl, 3-hexyl, 1-heptyl, 3-heptyl, 1-octyl, 2-ethylhex-1-yl, 1-nonyl, 1-decyl, 1-dodecyl, 1-lauryl and 1-octadecyl, Preference is given to alkyl groups having 6-20 carbon atoms, Particular preference is especially also given to branched alkyl groups that lead to a lower glass transition temperature TG compared to linear alkyl groups having the same number of carbon atoms.

Copolymers for use with particular preference in accordance with the invention as component (c) are those based on ethene and alkyl acrylates wherein the alkyl group is formed from 5-10 carbon atoms.

Very particular preference is given in accordance with the invention to copolymers in which the olefin, especially ethene, is copolymerized with 2-ethylhexyl acrylate.

Likewise suitable are mixtures of the acrylates or methacrylates described. Preference is given here to the use of more than 60% by weight, particular preference to the use of more than 90% by weight and very particular preference to the use of 100% by weight of 2-ethylhexyl acrylate, based on the total amount of acrylates and methacrylates in the copolymer for use as component (c).

In a further-preferred embodiment, the further reactive functional groups of the copolymer (c) are introduced into the copolymer for use as component (c) exclusively via the acrylates or methacrylates, the functional groups being selected from the group comprising epoxides, oxetanes, anhydrides, imides, aziridines, furans, acids, amines, oxazolines.

The content of the acrylates or methacrylates in the copolymer for use as component (c) is in the range from 10% to 50% by weight, preferably in the range from 25% to 45% by weight.

Features of the copolymers for use as component (c) are not just the composition but also the low molecular weight. Accordingly, copolymers suitable as component (c) for the inventive compositions and the moulding compositions obtainable therefrom are only those which have a melt flow index (MFI) measured at 190° C. and a load of 2.16 kg in the range from 100 g/10 min to 800 g/10 min, preferably in the range from 150 g/10 min to 800 g/10 min, more preferably in the range from 300 g/10 min to 700 g/10 min.

Copolymers suitable as component (c) may be selected from the group of the materials supplied by Arkema under the Lotryl® EH brand name, which usually find use as hot-melt adhesives. Especially preferred in accordance with the invention is a copolymer of ethane and ethylhexyl acrylate (EHA) which is supplied as Lotryl® 37 EH 550 [CAS No. 26984-27-0] by Arkema, Puteaux, France.

Component (d)

Fillers and reinforcers as component (d) in the context of the present invention are fibrous, acicular or particulate fillers and reinforcers. Preference is given to glass fibres, carbon fibres, glass beads, amorphous silica, calcium silicate, calcium metasilicate, magnesium carbonate, kaolin, calcined kaolin, chalk, powdered quartz, mica, phlogopite, barium sulphate, feldspar, wollastonite or montmorillonite, particular preference to glass fibres, especial preference to glass fibres made from E glass. The fibrous or particulate reinforcers, in a preferred embodiment, are provided with suitable surface modifications, especially surface modifications containing silane compounds, for better compatibility with the polyamide for use as component (a).

According to the invention, chopped glass fibres having a mean starting length in the range from 1 to 50 mm, more preferably in the range from 1 to 10 mm, most preferably in the range from 2 to 7 mm, are used for component (d). The glass fibres of component (d) may, as a result of the processing to give the moulding composition or to give the product, have a lower d97 or d50 value in the moulding composition or in the product than the glass fibres originally used. Thus, the arithmetic mean of the glass fibre length after processing is frequently only in the range from 150 μm to 300 μm. The median or d50 is the most important parameter as a measure of the average particle size. 50% by volume of the sample is finer and the other 50% is coarser than d50, d25, d75 or d97 are defined analogously (Clariant Analytical Services, Technical Sheet 106).

The glass fibres for use with preference as component (d) in accordance with the invention [CAS No. 65997-17-3] preferably have a median fibre diameter in the range from 7 to 18 μm, more preferably in the range from 9 to 15 μm, which should be determined by at least one means available to the person skilled in the art. The glass fibres for use as component (d) are preferably added in the form of chopped fibres or in the form of continuous fibres or ground glass fibres. In the context of the present invention, a length and diameter thickness determination of the individual fibres is effected semi-automatically using scanning electron micrographs (SEM) by means of a digitizer and computer-assisted data capture.

The fibres, especially glass fibres, for use with preference as component (d) are preferably modified with a suitable size system or an adhesion promoter or adhesion promoter system, more preferably with a silane -based adhesion promoter.

Very particularly preferred silane-based adhesion promoters for the modification of the fillers or reinforcers, especially glass fibres, are silane compounds of the general formula (I)

(X—(CH₂)_{q})ₖ—Si—(O—CᵣH₂ᵣ+1)₄₋ₖ (I)

in which the substituents are defined as follows:

X: NH₂—, HO—,

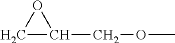

q: an integer from 2 to 10, preferably 3 to 4,

r: an integer from 1 to 5, preferably 1 to 2,

k: an integer from 1 to 3, preferably 1.

Especially preferred adhesion promoters are silane compounds from the group of aminopropyltrimethoxysilane, aminobutyltrimethoxysilane, aminopropyltriethoxysilane, aminobutyltriethoxysilane, and the corresponding silanes containing a glycidyl group as the X substituent in formula (I).

For the modification of the glass fibres used with especial preference as component (d), the size systems preferably containing silane compounds as adhesion promoters are used preferably in amounts in the range from 0.05% to 2% by weight, more preferably in the range from 0.25% to 1.5% by weight and especially in the range from 0.5% to 1% by weight (% by weight after drying), based on the glass fibres for surface coating. The proportion by weight of adhesion promoters, especially shares, in the surface coating of the glass fibres is preferably 2%-10% by weight of the dry matter.

Component (e)

According to the invention, at least one form of carbon black and/or nigrosin, especially carbon black, is used as component (e). The term “carbon black”, as opposed to soot, is usually used for the industrial raw material produced under controlled conditions, and sometimes also the older term “industrial carbon black”. industrial carbon black is a polymorph of carbon having a very high surface area and is used particularly as a black pigment. The classification of standard carbon blacks by the US ASTM standard is customary internationally. Preference is given to the use of carbon black having a median particle size in the range from 5 to 60 nm, more preferably in the range from 10 to 40 nm and most preferably in the range from 15 to 25 nm. The carbon blacks for use in accordance with the invention [CAS No. 1333-86-4] are preferably used in the form of powder or beads. Carbon blacks for use with very particular preference as component (e) are selected from the group of ASTM Standards N220, N234, N294, N330, N326, N347, N440, N472, N539, N550, N568, N601, N660, N762, N770, N785, N880 and N990 (http://de.wikipedia.org/wikiRu%C3%9F). Carbon black for use in accordance with the invention as component (e) is also referred to as black pigment (C. I. Pigment Black 7). Further products are available from Orion Carbons as PRINTEX, HIBLACK, AROSPERSE, NIPex, NEROX, COLOUR BLACK, SPECIAL BLACK black pigments, or, from the manufacturer Birla Carbon, the products Raven, Conductex, Copeblack, or, from the manufacturer Cabot, the products BLACK PEARLS, ELFTEX, MOGUL, MONARCH, REGAL, SPHERON, STERLING, VULCAN, CSX, CRX, IRX, UNITED.

Nigrosin [CAS No. 8005-03-6] is a mixture of synthetic black dyes (CI 50415, Solvent Black 5) and is prepared from a mixture of nitrobenzene, aniline and aniline hydrochloride in the presence of a copper or iron catalyst. The most important industrial uses are as a colourant for coating materials and in marker pen inks. Nigrosin is available, for example, from Kremer Pigments GmbH & Co. KG, Aichstetten, Germany.

Component (f)

Further additives as component (f) in the context of the present invention are different from components (b) to (e), and are preferably substances from the group of thermal stabilizers, UV stabilizers, gamma ray stabilizers, hydrolysis stabilizers, antistats, emulsifiers, nucleating agents, plasticizers, processing aids, impact modifiers, lubricants, demoulding agents, dyes or pigments. These and further suitable additives are prior art and can be found by the person skilled in the art, for example, in the Plastics Additives Handbook, 5th Edition, Hanser-Verlag, Munich, 2001, pages 80-84, 546-547, 688, 872-874, 938, 966.

The additives for use as component (f) can be used alone or in a mixture, or in the form of masterbatches.

Additional thermal stabilizers for use with preference in accordance with the invention as additive (f) are copper compounds, especially copper halides, in combination with alkali metal halides and/or alkaline earth metal halides, preferably sodium chloride or calcium chloride, manganese chloride, sterically hindered phenols and/or phosphites, phosphates, preferably disodium dihydrogendiphosphate, hydroquinones, aromatic secondary amines, especially diphenylamines, substituted resorcinols, salicylates, benzotriazoles or benzophenones, and variously substituted representatives of these groups and/or mixtures thereof.

UV stabilizers for use with particular preference in accordance with the invention as additive (f) are substituted resorcinols, salicylates, benzotriazoles or benzophenones.

Impact modifiers or elastomer modifiers for use in accordance with the invention as additive (f) are different from component (c) and are preferably copolymers preferably formed in turn from at least two of the following group of monomers: ethylene, propylene, butadiene, isobutene, isoprene, chloroprene, vinyl acetate, styrene and acrylonitrile. The copolymers may contain compatibilizing groups, preferably maleic anhydride or epoxide.

Dyes or pigments for use in accordance with the invention as additive (f) are different from component (e) and are preferably inorganic pigments, more preferably titanium dioxide, ultramarine blue, iron oxide or zinc sulphide, and also organic pigments, more preferably phthalocyanines, quinacridones, perylenes, and dyes, more preferably anthraquinones as colourants and other colourants.

Nucleating agents for use in accordance with the invention as additive (f) are preferably sodium phenylphosphinate or calcium phenylphosphinate, aluminium oxide or silicon dioxide or talc, more preferably talc.

Lubricants and/or demoulding agents for use in accordance with the invention as additive (f) are preferably long-chain fatty adds, especially stearic acid, salts thereof, especially calcium stearate or zinc stearate, and the ester derivatives or amide derivatives thereof, especially ethylenebisstearylamide, glyceryl tristearate, stearyl stearate, montan waxes, especially esters of montan acids with ethylene glycol, and low molecular weight polyethylene or polypropylene waxes in oxidized and non-oxidized form or, if not used as nucleating agent, talc. Lubricants and/or demoulding agents particularly preferred in accordance with the invention are in the group of the esters or amides of saturated or unsaturated aliphatic carboxylic adds having 8 to 40 carbon atoms with aliphatic saturated alcohols or amines having 2 to 40 carbon atoms.

Particular preference is given in accordance with the invention to using talc, preferably microcrystalline talc. Talc [GAS No. 14807-98-6] is a sheet silicate having the chemical composition Mg₃[Si₄O₁₀(OH)₂], which, according to the polymorph, crystallizes as talc-1A in the triclinic crystal system or as talc-2M in the monoclinic crystal system (http://de.wikipedia.org/wiki/Talkum). Talc for use in accordance with the invention can be purchased, for example, as Mistron® R10 from Imerys Talc Group, Toulouse, France (Rio Tinto Group). According to the invention, microcrystalline talc is understood to mean a talc having a median d50 diameter less than or equal to 4.5 microns. Preferably, a microcrystalline talc having a d95 fraction diameter of less than or equal to 15 microns is used.

“Median d50 diameter” is understood to mean a diameter at which 50% by weight of the particles have a size less than the stated diameter; “D₉₅ fraction diameter” is understood to mean a diameter at which 95% by weight of the particles have a size less than the stated diameter. For non-spherical particles, the size is determined via the equivalent spherical diameter (Stokes diameter). All these d50 and d95 diameter measurements are conducted with a “Sédigraph” (trademark) apparatus by gravitational sedimentation to the standard AFNOR X11-683, Standard talc has a d50 in the order of magnitude of 8 to 15 microns. In a further preferred embodiment, the inventive compositions or the thermoplastic moulding compositions that can be produced therefrom comprise mixtures of the abovementioned lubricants and/or demoulding agents.

Components (b) and (c) can be used in different ratios to one another. In the context of this invention, preference is given to relative weight ratios of component (b) to component (c) between 5:1 and 1:5, more preferably between 3:1 and 1:3, most preferably between 2:1 and 1:2.

The inventive compositions may also find use in thermoplastic fibre composite materials. The present invention therefore also provides thermoplastic fibre composite materials wherein the thermoplastic matrix contains the inventive compositions in the form of moulding compositions. Thermoplastic fibre composite materials in the context of the present invention are continuous fibre-reinforced semifinished products which are also referred to as organosheets and are obtainable, for example, from Bond-Laminates GmbH, Briton, Germany under the TEPEX® brand. These organosheets are fully impregnated and consolidated semifinished products based on continuous fibres, especially glass fibres, carbon fibres or aramid fibres. A production process for organosheets is known, for example, from EP 1 923 420 A1, the contents of which are hereby fully embraced.

Most preferably, the present invention relates to compositions comprising polyamide, preferably nylon-6 or nylon-6,6, dipentaerythritol, copolymer of ethane and C₄-C₁₀-alkyl acrylate, preferably 2-ethylhexyl acrylate, and at least one montan wax ester.

In one embodiment, the present invention relates to compositions comprising polyamide, preferably nylon-6 or nylon-6,6, dipentaerythritol, copolymer of ethene and C₄-C₁₀-alkyl acrylate, preferably 2-ethylhexyl acrylate, at least one montan wax ester, carbon black and/or nigrosin, alkali metal bromide, preferably potassium bromide, and copper halide, preferably copper(I) iodide.

Process

The present invention further provides a process for producing moulding compositions based on the inventive compositions, by mixing components (a) to (c) and optionally also (d) and/or (e) and/or (f) in appropriate proportions by weight within the above-specified percentages by weight, preferably in at least one mixing unit. Preferred mixing units are Buss kneaders or twin-shaft extruders. Preferably, the mixing of the components is accomplished at temperatures in the range from 220 to 400° C., preferably in the range from 220 to 350° C. Preferably, the mixing is effected by joint blending, mixing, kneading, compounding, extruding or rolling of the components. More preferably, the components are mixed by compounding in at least one mixing unit, preferably in a co-rotating twin-screw extruder or Buss kneader. It may be advantageous to premix individual components.

Inventive processes for producing products by means of extrusion or injection moulding work preferably at melt temperatures in the range from 230 to 330° C., more preferably in the range from 250 to 300° C., and optionally additionally at pressures of not more than 2500 bar, preferably at pressures of not more than 2000 bar, more preferably at pressures of not more than 1500 bar and most preferably at pressures of not more than 750 bar.

In the case of extrusion, also referred to as strand pressing, solid to viscous thermoplastic moulding compositions are forced under pressure continuously out of a shaped orifice, also referred to as nozzle, die or mouthpiece. This gives rise to products having the cross section of the orifice in theoretically any length (http://de.wikipedia.org/wiki/Extrusion_(Verfahrenstechnik)). The basic process steps of the profile extrusion process, one process form of extrusion, are:

1. plasticizing and providing the thermoplastic melt in an extruder,

2. extruding the thermoplastic melt strand through a calibration sleeve having the cross section of the profile to be extruded,

3. cooling the extruded profile on a calibrating table,

4. transporting the profile onward using a draw system beyond the calibration table,

5. cutting the previously continuous profile to length in a cutting system,

6. collecting the profiles which have been cut to length on a collecting table.

The description of the profile extrusion of nylon-6 and nylon-6,6 is given in Kunststoff-Handbuch [Plastics Handbook] 3/4, Polyamide [Polyamides], Carl Hanser Verlag, Munich 1908, pages 374-384. Extrusion systems for production of profiles consist of: extruder, profile mould, calibration, cooling zone, caterpillar take-off and roll take-off, separating device and tilting chute.

The process of blow moulding is described, for example, at http://www.blasformen.com/. In blow moulding, in the first process step, a heated extruder is used to draw in polymer pellets, to compact, degas, heat and plasticize them, and to homogenize them to a plastic polymer strand.

In the next process step, the polymer mass is conducted into a parison die flanged onto the extruder. The polymer melt is shaped therein to a parison, which leaves a nozzle in the vertically downward direction.

The parison diameter is matched to the article to be fabricated with standard mandrel units and standard nozzle units of different size, which are flanged onto the parison die.

The parison thickness and the resulting weight of the blow-mouldings is predetermined by the selection of different diameter differences from mandrel to die.

The process of injection moulding features melting (plasticization) of the raw material, i.e. the thermoplastic moulding composition comprising the inventive mixtures which is to be processed, preferably in pellet form, in a heated cylindrical cavity, and injection thereof as injection moulding material under pressure into a temperature-controlled cavity. After the cooling (solidification) of the material, the injection moulding is demoulded.

The following phases are distinguished:

1. Plasticization/melting

2. Injection phase (filling operation)

3. Hold pressure phase (owing to thermal contraction in the course of crystallization)

4. Demoulding.

An injection moulding machine consists of a closure unit, the injection unit, the drive and the control system. The closure unit includes fixed and movable platens for the mould, an end platen, and tie bars and drive for the movable mould platen (toggle joint or hydraulic closure unit).

An injection unit comprises the electrically heatable barrel, the drive for the screw (motor, gearbox) and the hydraulics for moving the screw and the injection unit. The task of the injection unit is to melt the powder or the pellets, to meter them, to inject them and to maintain the hold pressure (owing to contraction). The problem of the melt flowing backward within the screw (leakage flow) is solved by non-return valves.

In the injection mould, the incoming melt is then separated and cooled, and hence the component to be produced is produced. Two halves of the mould are always needed for this purpose. In injection moulding, the following functional systems are distinguished:
runner system
shaping inserts
venting
machine casing and force absorber
demoulding system and movement transmission
temperature control

In contrast to injection moulding, extrusion involves using a continuously shaped strand of the inventive thermoplastic moulding composition in the extruder, the extruder being a machine for producing products based on shaped thermoplastics. The following phases are distinguished:
single-screw extruder and twin-screw extruder and the respective sub-groups,
conventional single-screw extruder, conveying single-screw extruder,
contra-rotating twin-screw extruder and co-rotating twin-screw extruder.

Products

The present invention consequently also relates to products, preferably mouldings, shaped bodies, fibres or semifinished products, obtainable by extrusion or injection moulding of the inventive thermoplastic moulding compositions.

Uses

The present invention finally relates to the use of the inventive compositions for production of moulding compositions for the production of articles for the electrical, electronics, telecommunications, information technology, solar and computer industries, for the household, for sport, for medical applications or for the entertainment industry, more preferably for motor vehicles, most preferably for the engine compartment of motor vehicles.

The present application also provides for the use of the moulding compositions which can be produced from the inventive compositions in extrusion, preferably in an extrusion process or in profile extrusion, in injection moulding or in blow moulding, for production of products, preferably of mouldings or semifinished products.

Also provided is the use of at least one polyol having at least two and not more than 12 hydroxyl groups per molecule and a mean molecular weight in the range from 64 to 2000 g/mol in combination with at least one copolymer of at least one olefin with at least one methacrylate or acrylate of an aliphatic alcohol having a melt flow index (MFI) measured at 190° C. and a load of 2.16 kg in the range from 100 g/10 min to 800 g/10 min for reduction or prevention of thermooxidative damage to polyamide-based moulding compositions or polyamide-based products that can be produced from these moulding compositions.

### EXAMPLES

The individual components of the inventive compositions and the components of the comparative examples were mixed in twin-shaft extruder of the ZSK 26 Compounder type from Coperion Werner & Pfleiderer (Stuttgart, Germany) at a temperature of about 280° C., discharged as a strand into a water bath, cooled until pelletizable and pelletized. The pellets were dried to constant weight at 70° C. in a vacuum drying cabinet.

Subsequently, the pellets were processed on an injection moulding machine of the Arburg SG370-173732 type at melt temperatures in the range from 270 to 300° C. and mould temperatures in the range from 80 to 100° C. to give dumbbell specimens (thickness 4 mm to ISO 528) and sheets having the dimensions 400·250·1.5 mm³ (Ex. 1 and Comp. Ex. 1), and also to give sheets having the dimensions 60·4·4 mm³ (Ex. 2 and Comp. Ex. 2 and 3).

The mechanical properties of the products produced from the inventive compositions in Example 2 and from the compositions for Comparative Examples 2 and 3 were determined in the tensile test to ISO 527. Stability against thermooxidative damage is tested by storing the specimens at 200° C. for 1008 h with a subsequent tensile test.

The viscosity of the thermoplastic moulding compositions obtained on the basis of the inventive compositions in Example 1 and the viscosity of the moulding composition for Comparative Example 1 in the molten state was determined with a capillary viscometer to ISO 11443 at a temperature of 290° C.

The viscosity of the thermoplastic moulding compositions in Example 2 and Comparative Examples 2 and 3 in the molten state was determined as a volume flow index to DIN EN ISO 1133-1 at a temperature of 290° C. with a pre-heating time of 10 min and a load of 5 kg.

Sheets in Example 1 and Comparative Example 1 were subjected to two different sets of moist climatic conditions. The sheets were stored at 90% relative humidity (RH) and 85° C. for 48 h and at 90% RH and 40° C. for 168 h. The sheets in Example 2 and Comparative Examples 2 and 3 were stored at 85% RH and 85° C. for up to 672 h. Deposit formation after storage was scored with a deposits index between 1 and 6. A deposits index of 1 here means that no deposits were formed. A deposits index of 3 means clearly visible but thin deposits. A deposits index of 6 means severe formation of deposits over the entire sheet.

The compositions shown in Tables 1 and 2 below were all processed and tested in the manner described above.

Materials Used:

Nylon-6,6, e.g. Vydyne® 50 BWFS from Ascend Performance Materials LLC

Nylon-6, linear with a viscosity number determined in a 0.5% by weight solution in 96% by weight sulphuric acid at 25° C. to ISO 307 of 145 ml/g

Glass fibres, e.g. CS7928 from Lanxess Deutschland GmbH

Montan wax ester, e.g. Licowax® E from Clariant GmbH [CAS No. 73138-45-1]

Copper(I) iodide [CAS No. 7681-65-4], d99<70 μm

Potassium bromide [CAS No. 7758-02-3], d99<70 μm

Talc [CAS No. 14807-96-6]

Organic stabilizer, e.g. Irganox® 1098 [CAS No. 23128-74-7] from BASF SE, N,N′-hexamethylenebis[3-(3,5-di-t-butyl-4-hydroxyphenyl)propionamide]

Impact modifier, e.g. Tafmer® MH7020 from Mitsui Chemicals, Inc., an acid-modified polyolefin [CAS No. 63625-38-5].

Dipentaerythritol [CAS No. 128-58-9], e.g. Di-Penta 93 from Perstorp Service GmbH

Copolymer of ethene and 2-ethylhexyl acrylate, e.g. Lotryl® 37 EH 550 [CAS No. 26984-27-0] from Arkema GmbH

TABLE 1

| | Comp. Ex. 1 | Ex. 1 |
|---|---|---|
| Nylon-6,6 | 38.23 | 36.73 |
| Glass fibres | 60.00 | 60.00 |
| Montan wax ester | 0.09 | 0.09 |
| Copper(I) iodide | 0.02 | 0.02 |
| Potassium bromide | 0.06 | 0.06 |
| Dipentaerythritol | 1.35 | 1.35 |
| Copolymer of ethene and 2-ethylhexyl acrylate | | 1.50 |
| Carbon black | 0.15 | 0.15 |
| Nigrosin | 0.10 | 0.10 |
| Melt viscosity at 270° C./1000 1/s [Pa s] | 180 | 181 |
| Melt viscosity at 270° C./1500 1/s [Pa s] | 154 | 148 |
| Melt viscosity at 290° C./1000 1/s [Pa s] | 82 | 79 |
| Melt viscosity at 290° C./1500 1/s [Pa s] | 71 | 69 |
| Deposits index after 24 h at 85° C./90% RH | 2.5 | 1.0 |
| Deposits index after 168 h at 40° C./90% RH | 2.5 | 1.0 |

TABLE 2

| | Comp. | Comp. | |
|---|---|---|---|
| | Ex. 2 | Ex. 3 | Ex. 2 |
| Nylon-6 | 67.32 | 65.32 | 63.32 |
| Glass fibres | 30.00 | 30.00 | 30.00 |
| Montan wax ester | 0.16 | 0.16 | 0.16 |
| Talc | 0.02 | 0.02 | 0.02 |
| Organic stabilizer | 0.50 | 0.50 | 0.50 |
| Impact modifier | 2.00 | 2.00 | 2.00 |
| Dipentaerythritol | | 2.00 | 2.00 |
| Copolymer of ethene and 2-ethylhexyl | | | 2.00 |
| acrylate | | | |
| Volume flow index at 290° C./5 kg | 69 | 217 | 241 |
| [cm³/10 min] | | | |
| Deposits index after 168 h at 85° C./85% RH | 1.0 | 1.5 | 1.0 |
| Deposits index after 672 h at 85° C./85% RH | 1.0 | 2.0 | 1.0 |
| Breaking stress after 0 h at 200° C. [MPa] | 176 | 167 | 154 |
| Breaking stress after 1008 h at 200° C. [MPa] | 151 | 183 | 171 |
| Relative change in breaking stress [%] | −14 | +10 | +11 |

In Table 1, the thermoplastic moulding compositions from Comparative Example 1 show distinct formation of deposits under both sets of climatic conditions tested. The addition of the copolymer of ethene and 2-ethylhexyl acrylate distinctly reduces this formation of deposits. After storage under both sets of climatic conditions, no deposit formation is observed any longer. The viscosity of the moulding composition is not increased by addition of the copolymer. It can be concluded from this that the flow-improving effect of the dipentaerythritol is not reduced by the addition of the copolymer.

In Table 2, comparison of the volume flow index results for Comparative Example 3 and Example 2 shows that the addition of the copolymer does not impair the viscosity-reducing effect of dipentaerythritol in the case of these moulding compositions either. The positive effect of dipentaerythritol is apparent on comparison of the volume flow index results for Comparative Examples 2 and 3.

The results for the deposit formation index after storage at 85° C./85% RH show that the addition of dipentaerythritol leads to a distinct rise in the formation of deposits (Comp. Ex. 2 and 3). This effect can be avoided through the additional addition of the copolymer in Example 2. In this example, no deposit formation is observed any longer.

In the case of the moulding composition comprising conventional copper stabilizer (Comp. Ex. 2), storage over 1008 h at 200° C. leads to a 14% reduction in breaking stress in the tensile test. The stabilizing effect of the dipentaerythritol leads to a 10% increase in the breaking stress after storage for 1008 hours at 200° C. (Comp. Ex. 3). This stabilizing effect is not adversely affected by the addition of the copolymer in Example 2. In Example 2, the breaking stress increases by 11% after storage for 1008 h at 200° C.

What is claimed is:

1. A composition comprising
(a) 10% to 98,8% by weight of at least one polyamide,
(b) 0.1% to 10% by weight of at least one polyol having at least two and not more than 12 hydroxyl groups per molecule and a mean relative molecular mass in the range from 64 to 2000 g/mol and
(c) 01% to 10% by weight of at least one copolymer of at least one olefin with at least one methacrylate or acrylate of an aliphatic alcohol which has a melt flow index (MFI) measured at 190° C. with a load of 2.16 kg in the range from 100 g/10 min to 800 g/10 min, with the proviso that the sum total of all the percentages by weight is always 100 and, in the case of use of polyols (b) which are mixtures of oligomeric and/or polymeric polyols, the number-average molecular weight (Mₙ) rather than the relative molecular mass determines the limit of the range for that part of the mixture.

2. The composition according to claim 1, comprising in addition to components (a) to (c), also d) 5% to 80% by weight of at least one filler or reinforcer and where the proportions of components (a) to (c) are reduced such that the sum total of all the percentages by weight is always 100.

3. The composition according to claim 2, wherein the filler or reinforcer are glass fibers or carbon fibers.

4. The composition according to claim 2, comprising in addition to components (a) to (d), or instead of (d), also
(e) 0.1% to 20% by weight of at least one form of carbon black and/or nigrosin, where the proportions of components (a) to (c) and any (d) are reduced such that the sum total of all the percentages by weight is always 100.

5. The composition according to any of claim 1, wherein the at least one polyamide comprises at least one amorphous polyamide, at least one semicrystalline polyamide, or at least one partly crystalline polyamide.

6. The composition according to claim 5 wherein the at least one polyamide comprises at least one partly crystalline polyamide.

7. The composition according to claim 6, wherein the at least one partly crystalline polyamide has a melting point of at least 180° C.

8. The composition according to claim 6, wherein the at least one partly crystalline polyamide has a viscosity number determined in a 0.5% by weight solution in 96% by weight sulphuric acid at 25° C. to ISO 307 in the range from 80 to 180 ml/g.

9. The composition according to claim 8, wherein the at least one polyamide comprises aliphatic or semiaromatic polyamides.

10. The composition according to claim 9 wherein the at least one polyamide comprises at least one polyamide prepared from one or more of the monomers ε-caprolactam, adipic acid, terephthalic acid, hexamethylenediamine, tetramethylenediamine or 2-methylpentane-1,5-diamine.

11. The composition according to claim 10, wherein the at least one polyamide is PA6, PA66 or a copolyamide of PA6 or PA66.

12. The composition according to claim 1, wherein the at least one polyol comprises at least one polyol selected from the group consisting of pentaerythritol, dipentaerythritol and tripentaerythritol.

13. The composition according to claim 1, wherein the copolymer (c) consists to an extent of less than 4% by weight of monomer units containing further reactive functional groups.

14. The composition according to claim 13, wherein the monomer unit is selected from the group comprising epoxides, oxetanes, anhydrides, imides, aziridines, furans, acids, amines, oxazolines.

15. The composition according to claim 14, wherein the olefin is copolymerized with 2-ethylhexyl acrylate in the copolymer (c).

16. The composition according to claim 15, wherein the olefin in the copolymer (c) is ethene.

17. The composition according to claim 1, wherein the mass ratio between component (b) and component (c) is between 5:1 and 1:5.

18. A process for producing products, the process comprising mixing compositions according to claim 1 in the proportions by weight specified in claim 1 to produce moulding compositions, and subjecting the moulding compositions to an injection moulding, extrusion or blow moulding operation.

19. The process according to claim 18, wherein the mixing is done by blending, mixing, kneading, compounding, extruding or rolling.

20. The process according to claim 18 or 19, wherein the mixing is done at a temperature in the range from 220° C. to 400° C.

21. A product obtained by injection moulding, extrusion or blow moulding of moulding compositions comprising the compositions according to claim 1.

22. A product according to claim 21, wherein the products comprise fibers, films, semifinished products or mouldings.

23. A method for reducing or preventing thermooxidative damage to polyimide-based moulding compositions or polyimide-based products produced from the moulding compositions, the method comprising forming the moulding composition with at least one polyol having at least two and not more than 12 hydroxyl groups per molecule and a mean relative molecular mass in the range from 64 to 2000 g/mol in combination with at least one copolymer of at least one olefin with at least one methacrylate or acrylate of an aliphatic alcohol having a melt flow index (MFI) measured at 190° C. and a load of 2.16 kg in the range from 100 g/10 min to 800 g/10 min, where the number-average molecular weight (Mn) replaces the relative molecular mass for that part of the mixture in the case of use of polyols that are mixtures of oligomeric and/or polymeric polyols.

24. The method according to claim 23, wherein the products are articles for the electrical, electronics, telecommunications, information technology, solar and computer industries, for the household, for sport, for medical applications, for the entertainment industry, for motor vehicles, or products for the engine compartment of motor vehicles.
